(19) United States
(12) Patent Application Publication
(10) Pub. No.: US 2026/0086198 A1
(43) Pub. Date: Mar. 26, 2026

(54) RADAR WARNING RECEIVER PERFORMANCE SIMULATION TOOL

(71) Applicant: BAE SYSTEMS Information and Electronic Systems Integration Inc., Nashua, NH (US)

(72) Inventor: Alexander JIRELE, Bloomfield, NJ (US)

(73) Assignee: BAE SYSTEMS Information and Electronic Systems Integration Inc., Nashua, NH (US)

(21) Appl. No.: 18/415,274

(22) Filed: Jan. 17, 2024

(51) Int. Cl. G01S 7/40

(52) U.S. Cl. CPC G01S 7/4021; G01S 7/4052

(57) ABSTRACT

Techniques are provided for simulating the performance of a radar warning receiver (RWR). A methodology implementing the techniques according to an embodiment includes generating a scan matrix to identify RWR dwells as a function of time. The generation is based on a provided scan schedule associated with a threat. The method also includes simulating dwell detections and dwell no-detects based on a provided probability of intercept (POI) associated with the threat. A dwell detection is indicative of an occurrence of an illumination by the threat in the RWR dwell and a dwell no-detect is indicative of an absence of an illumination by the threat in the dwell. The method further includes processing the dwell detections and dwell no-detects to generate a threat declaration based on a processing algorithm of the RWR associated with the threat. The method further includes generating a report comprising results of the processing.

### STATEMENT OF GOVERNMENT INTEREST

This invention was made with United States Government assistance under Contract No. FA8523-17-C-0018. The United States Government has certain rights in this invention.

### FIELD OF DISCLOSURE

The present disclosure relates to radar warning receivers, and more particularly to a performance simulation tool for radar warning receivers.

### BACKGROUND

Radar warning receivers (RWRs) are employed to scan a radio frequency (RF) spectrum, detect illuminations from threats within that spectrum, and provide a warning of those threats, for example to a pilot of an aircraft. RWRs usually do not have the capability to instantaneously scan the entire bandwidth of the RF spectrum in which threats operate, and so they typically hop from one dwell (e.g., frequency sub band and time slot) to another dwell, searching for threats based on a scan schedule. One method to test the efficacy of a scan schedule is to employ an RWR in a laboratory setting, along with an RF threat generator to inject RF threat waveforms into the RWR, to measure the performance of the RWR over time. Another method involves conducting actual test flights and threat scenarios. However, such approaches may be relatively expensive and time consuming.

### BRIEF DESCRIPTION OF THE DRAWINGS

FIG. 1 illustrates an implementation of an RWR performance simulation tool, in accordance with certain embodiments of the present disclosure.

FIG. 2 illustrates RWR scans in an RF threat space, in accordance with certain embodiments of the present disclosure.

FIG. 3 is a block diagram of the RWR performance simulator of FIG. 1, configured in accordance with certain embodiments of the present disclosure.

FIG. 4 illustrates a scan matrix, in accordance with certain embodiments of the present disclosure.

FIG. 5 illustrates simulation inputs and outputs, in accordance with certain embodiments of the present disclosure.

FIG. 6 illustrates simulated dwell detects and declarations, in accordance with certain embodiments of the present disclosure.

FIG. 7 is a flowchart illustrating a methodology for RWR performance simulation, in accordance with an embodiment of the present disclosure.

FIG. 8 is a block diagram of a processing platform configured to provide RWR performance simulation, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for a simulation tool to evaluate the performance of an RWR scan schedule and RWR algorithms. In an example, the techniques are implemented as an RWR simulator which enables an analyst or designer of a scan schedule to efficiently simulate the performance of the RWR against selected threats under a given scan schedule. The simulator can generate thousands of dwells and calculate the estimated performance of the RWR over many threat engagement hours in seconds or minutes rather than the hours of real-time testing that would be needed using an RWR or conducting actual flight tests.

In accordance with an embodiment, the RWR simulator includes a scan matrix generator configured to generate a scan matrix to identify RWR dwells as a function of time. The generation is based on a provided scan schedule that can be configured based on characteristics associated with a threat of interest. The RWR simulator also includes a dwell detection simulator configured to simulate dwell detections and no-detects based on a provided probability of intercept (POI). The POI can be configured to characterize the probability of illumination (or lack of illumination) by the threat within an RWR dwell. A dwell detection is indicative of an occurrence of an illumination by the threat in the RWR dwell, and a dwell no-detect is indicative of the absence of an illumination by the threat in the RWR dwell. The RWR simulator further includes a dwell detection processor configured to process the dwell detects and dwell no-detects to generate a threat declaration based on a processing algorithm of the RWR. The processing algorithm of the RWR can be configured based on characteristics associated with the threat, such as threat characteristics obtained through empirical and/or theoretical means (e.g., characteristics obtained from previous actual engagements with the threat and/or simulated characteristics). The RWR simulator further includes a performance report generator configured to generate a report comprising results of the processing.

It will be appreciated that the simulation techniques described herein may provide improved scan schedule and algorithm evaluation, compared to systems that use an RF threat generator to inject RF threat waveforms into an RWR, and measure the performance of the RWR over hours of flight time. Additionally, the disclosed techniques allow for rapid evaluation of different scan schedule or algorithm parameters against any selected threat type. Numerous embodiments and applications will be apparent in light of this disclosure.

### System Architecture

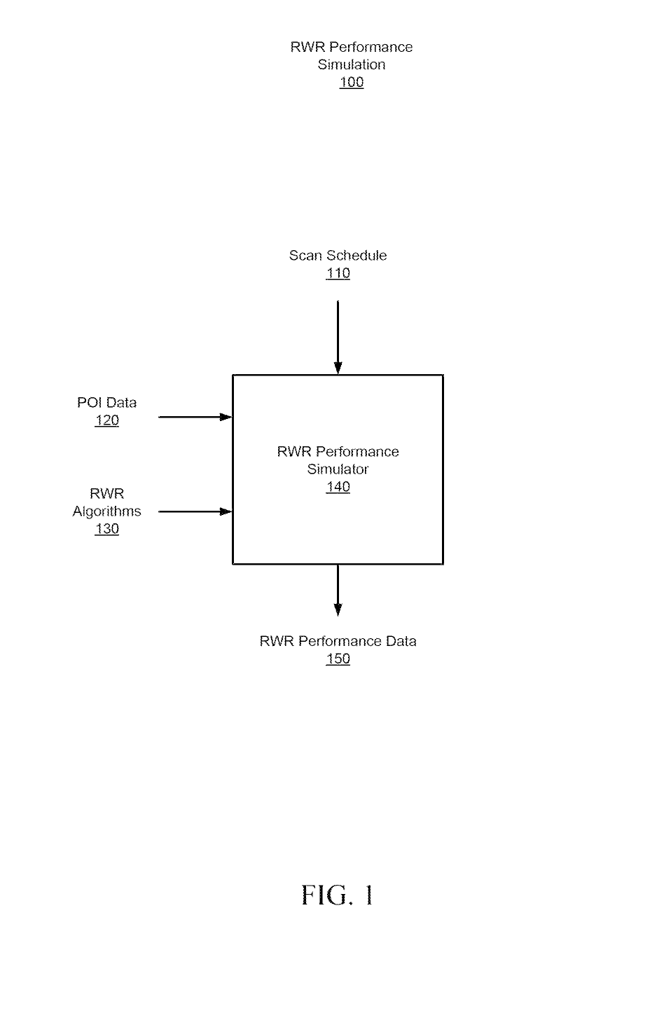

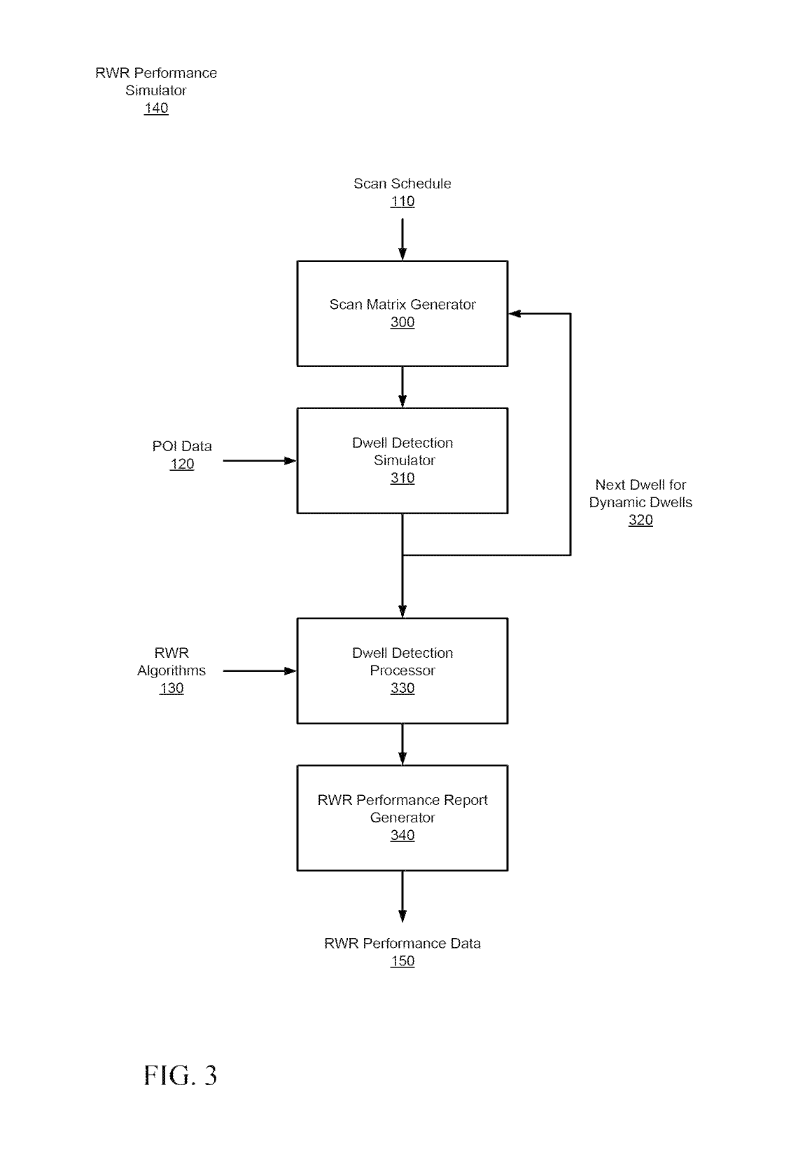

FIG. 1 illustrates an implementation 100 of an RWR performance simulation tool 140, in accordance with certain embodiments of the present disclosure. The RWR performance simulator 140 will be described in greater detail below in conjunction with the discussion of FIG. 3. At a high level, however, the simulator is configured to accept a scan schedule 110 and POI Data 120 that characterize (or are otherwise associated with) a threat of interest and simulate dwell detections for processing by the provided RWR algorithms 130. RWR performance data 150 is then generated based on the results of that processing. The performance data can be used to aid in the design of improved scan schedules and/or RWR algorithms.

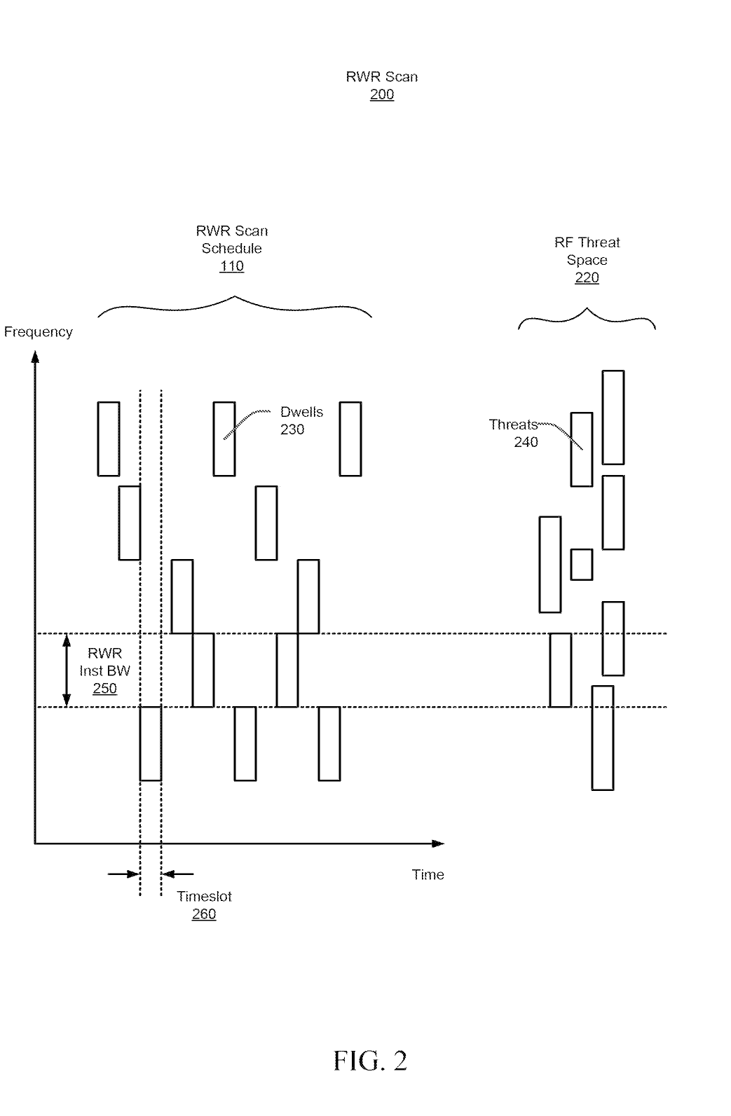

FIG. 2 illustrates RWR scans 200 in an RF threat space, in accordance with certain embodiments of the present disclosure. One simplified example of an RWR scan schedule 110 is shown on the left hand side of the figure. The RWR has an instantaneous bandwidth 250 which limits the scanning capability of the RWR to that frequency range during any given timeslot 260. The scan schedule is comprised of many dwells 230, during which the RWR will spend a period of time (e.g., a timeslot) looking in a given RF frequency range to collect RF energy from potential threats before moving on to the next dwell. The RF threat space 220 comprises any number of threats 240 which may illuminate the RWR at various frequencies and at various times. Many of the threats will not be continuously emitting RF energy in the direction of the RWR since certain threats are scanning the environment as well. As a result, any individual dwell may have less than a 100% chance of detecting RF energy from a threat. An estimate of the chance for any dwell to coincide with a threat illumination is referred to as the POI. One goal in the design of the scan schedule 110 is to try to maximize coincidence of the RWR dwells with the illumination periods of the most concerning threats.

FIG. 3 is a block diagram of the RWR performance simulator 140 of FIG. 1, configured in accordance with certain embodiments of the present disclosure. The RWR performance simulator 140 is shown to include a scan matrix generator 300, a dwell detection simulator 310, a dwell detection processor 330, and an RWR performance report generator 340.

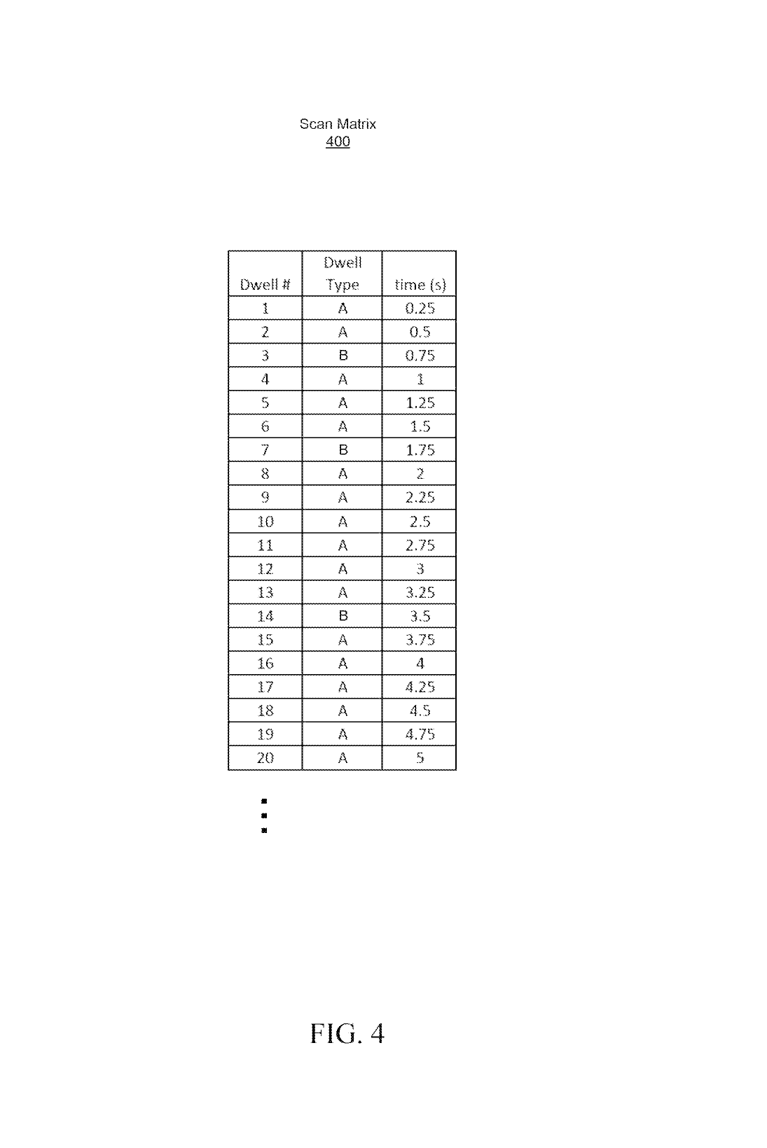

The scan matrix generator 300 is configured to generate a scan matrix based on a provided scan schedule 110 that is associated with a threat. In some embodiments, the scan schedule 110 may be generated by a mission data file generator, which is a separate tool used by an analyst to build a scan schedule. In some other embodiments, the scan schedule may be provided from any suitable source. In some embodiments, the scan matrix comprises a list of sequentially ordered RWR dwells, an indication of dwell type for each of the RWR dwells, and a start time for each of the RWR dwells. One example of a scan matrix 400 is shown in FIG. 4.

Different dwell types (e.g., type A versus type B) may be configured with different dwell parameters (dwell length, RF range), and therefore different POIs. For example, based on intelligence data, it may be known that a particular threat has a searching mode and a tracking mode. In the searching mode, the threat illuminates a relatively broader region looking for targets. Once a target has been detected, the threat switches to a tracking mode in which it illuminates the target more frequently to obtain additional tracking information such as trajectory, etc. The POI during track mode will therefore generally be higher than the POI during search mode.

The dwell detection simulator 310 is configured to simulate dwell detections based on a POI that characterizes or otherwise is associated with the threat. Dwell detections are indicative of an occurrence of an illumination of the RWR by the threat within the RWR dwell. Dwell no-detects are indicative of the absence of an illumination of the RWR by the threat within the dwell. In some embodiments, the POI may be determined based on the dwell type specified in the scan matrix or may be provided as POI data 120 from any other suitable source. Because different threats may search in different ways, illuminating the RWR at various frequencies and at various times according to their own schedules, which are independent of the RWR scan schedule, each threat may be associated with a unique POI. For example, one type of threat may illuminate the RWR relatively frequently, resulting in a higher POI, while another type of threat may illuminate the RWR less often, resulting in a lower POI.

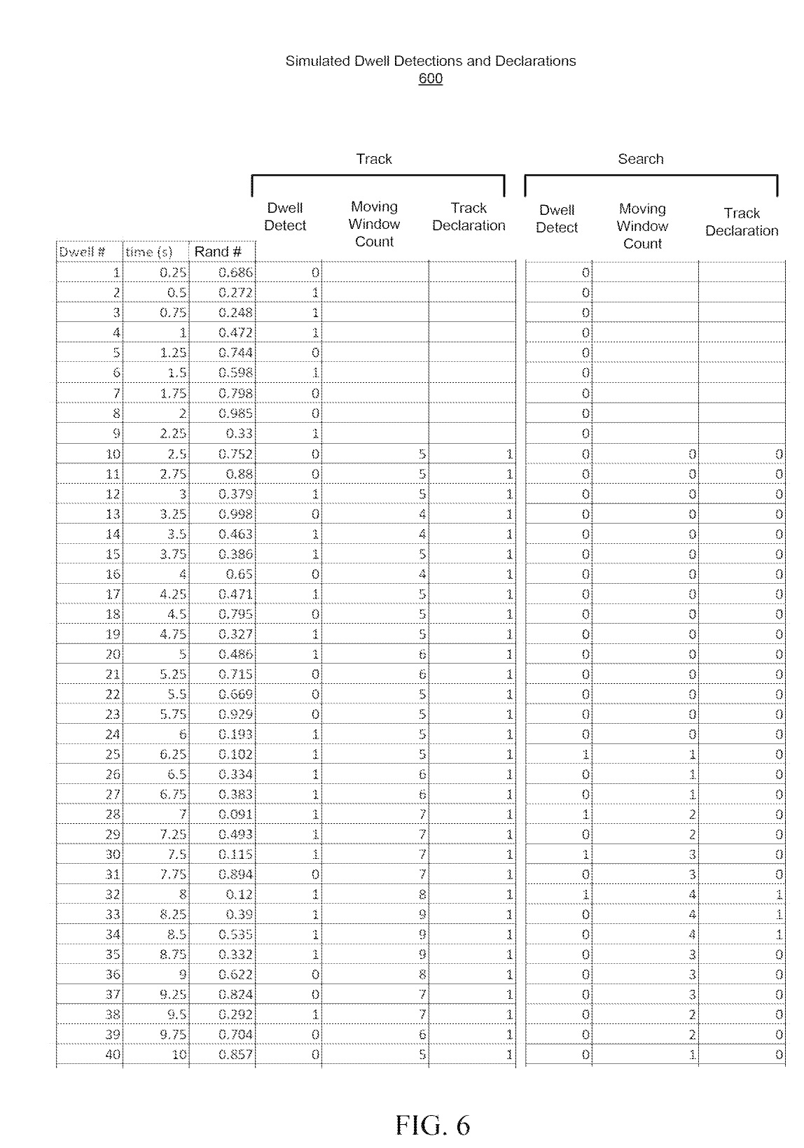

In some embodiments, the dwell detection simulator is configured to compare an output of a random number generator to a threshold value based on the POI and simulate the dwell detections based on the comparison. This allows for the simulation of dwell detections and no-detections as probabilistic events. For example, if the POI for a threat operating in track mode is 0.6 (a 60% chance of RWR dwell coincidence with threat illumination), then a simulated dwell detect for track mode is generated if the random number (normalized to the range of zero to one) is less than 0.6, otherwise a simulated dwell detect is not generated. Similarly, if the POI for a threat operating in search mode is 0.15 (a 15% chance of RWR dwell coincidence with threat illumination), then a simulated dwell detect for search mode is generated if the random number is less than 0.15, otherwise a simulated dwell detect is not generated. An example of simulated dwell detections for tracking and search modes is illustrated in FIG. 6, as described below.

In the case of dynamic dwells, for example where dwell types change, the process can loop back to the scan matrix generation to handle a new dwell type.

The dwell detection processor 330 is configured to process the dwell detections to generate a threat declaration using a processing algorithm 130 of the RWR. The processing algorithm 130 of the RWR is based on threat characteristics obtained through intelligence sources, prior experience with the threat, or by other suitable empirical means. Alternatively, or in addition to, the threat characteristics may be obtained based on theoretical analysis of a given threat.

One example of an RWR processing algorithm 130 comprises counting a number of the simulated dwell detects in a moving time window and generating the threat declaration by comparing the count to a detection threshold for declaration. For example, the moving window may be set to cover ten dwells and the detection threshold may be set to three. In that case, as the moving window advances in time through the simulated dwell detections, a track is declared whenever at least three detections occur during the window. This is also illustrated in FIG. 6, as described below.

The RWR performance report generator 340 is configured to generate a report 150 comprising results of the processing. In some embodiments, the report includes threat correct declaration rates, false alarm rates, and RWR response times resulting from the RWR processing algorithm. In some embodiments, the report may include age-out times (e.g., the time it takes for the RWR to remove the threat from display once the threat stops illuminating the RWR). In some embodiments, the report may include histograms of the response times and age-out times. The data included in the report may provide an indication of the simulated performance of the RWR based, for example, on the threat declarations, and can be used by an engineer or analyst to evaluate the performance of the RWR. For example, based on the report, the scan schedule and/or other parameters of the RWR algorithms may be modified and the simulation repeated to see if the results improve or degrade. The process can be iterated until a desired level of performance is achieved.

FIG. 4 illustrates a scan matrix 400, in accordance with certain embodiments of the present disclosure. As previously noted, the scan matrix 400 is generated based on a provided scan schedule 110. The scan matrix indicates a dwell type and a start time for each dwell. For example, dwell number 1 is of dwell type A and occurs at 0.25 second. Similarly, dwell number 3 is of dwell type B and occurs at 0.75 seconds. In some embodiments, any number of different dwell types may be indicated, and any other suitable information may be included in the scan matrix.

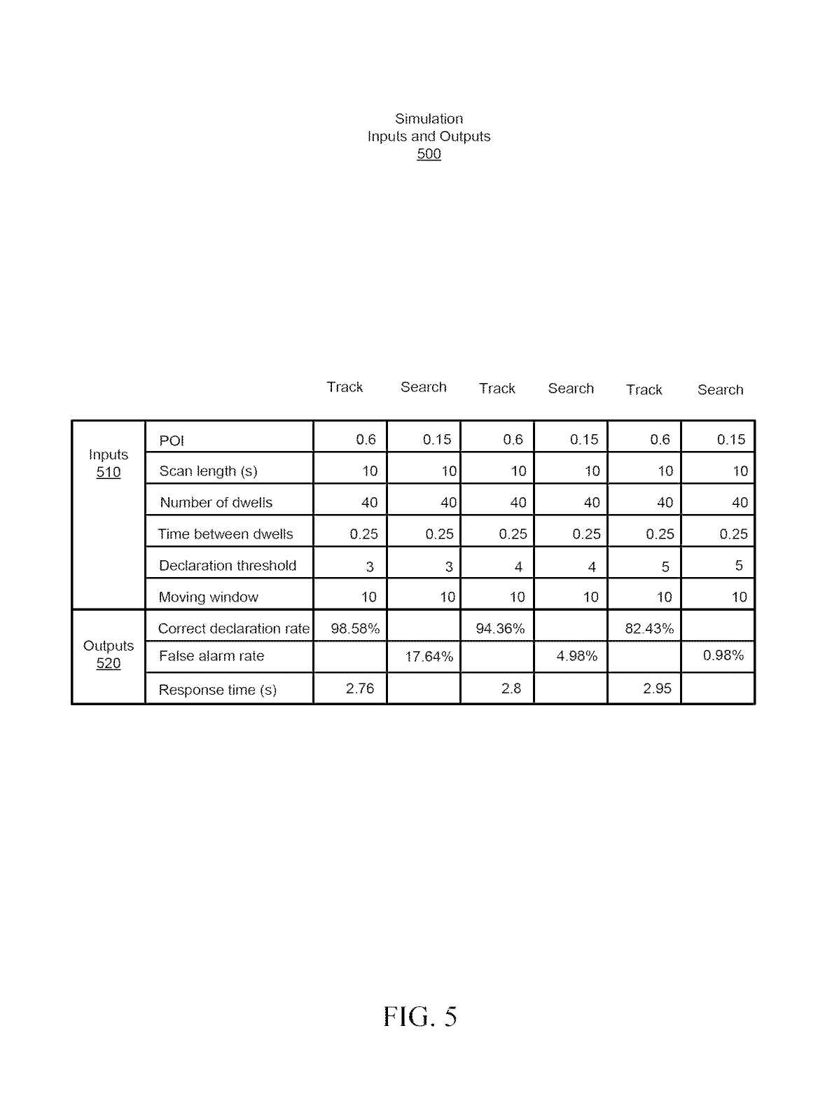

FIG. 5 illustrates simulation inputs and outputs 500, in accordance with certain embodiments of the present disclosure. Inputs 510 may include data indicative of POI data 120 and scan schedule 110. In the example shown here, inputs 510 include POI, scan length, number of dwells, time between dwells, declaration threshold, and moving window length. As further shown in this example, the POI is shown to vary between 0.6 for threats in track mode and 0.15 for a threat in search mode. Also, for each pair (track and search modes) the declaration threshold varies from 3 to 4 to 5 (over a moving window of length 10).

Outputs 520 may include correct declaration rate, false alarm rate, and response time, one or more of which may be included in the generated report or RWR performance data 150. In this example, the correct declaration rate (e.g., correctly declaring a threat to be in track mode) ranges from 98.58% for a declaration threshold of 3, to 94.36% for a declaration threshold of 4, to 82.43% for a declaration threshold of 5. As shown, the correct declaration rate decreases as the declaration threshold becomes more stringent. Further to this example, the false alarm rate (e.g., incorrectly declaring a threat to be in track mode when the threat was in search mode) ranges from 17.64% for a declaration threshold of 3, to 4.98% for a declaration threshold of 4, to 0.98% for a declaration threshold of 5. As shown, the false alarm rate decreases as the declaration threshold becomes more stringent. Additionally, a measurement of response time for the processing algorithm 130 to generate a declaration is provided. The response time is shown to increase from 2.76 seconds for a declaration threshold of 3, to 2.8 seconds for a declaration threshold of 4, to 2.95 seconds for a declaration threshold of 5. As shown in this example, requiring additional declarations results in a longer response time. For this example, a scan schedule analyst/designer might use the generated report 150 to choose, for instance, a declaration threshold of 4 out of 10 (e.g., the middle two columns) as a good balance to maximize the correct declaration rate while minimizing the false alarm rate with an acceptable response time.

FIG. 6 illustrates simulated dwell detects and declarations 600, in accordance with certain embodiments of the present disclosure. As previously noted, simulated dwell detections, for track and search mode, may be generated by comparison to a random number. Looking at dwell number 1, the random number generator produced 0.686. Since the POI for a simulated dwell detect for track mode is 0.6 (and using the example inputs from FIG. 5), a dwell detect is not generated (track dwell detect set to zero). Likewise, since the POI for a simulated dwell detect for search mode is 0.15, a dwell detect is not generated (search dwell detect set to zero). Advancing to dwell number 2, the generated random number is 0.272 so a track dwell detect is generated but a search dwell detect is not. At dwell number 25, the generated random number is 0.102, so both a track dwell detect and a search dwell detect are generated.

The moving window count columns show a running accumulation of the track dwell detects and search dwell detects. Since the moving window is of length 10 in this example, the first potential declarations are generated at dwell number 10. At dwell 10, the moving window count for tracking is 5 and, since this exceeds a selected declaration threshold of 4, track is declared. However, at dwell 10, the moving window count for searching is zero so track is not declared. As can be seen, it is not until dwell 32 that the moving window count for searching reaches four, at which point track is declared. By dwell 35, the moving window count for searching falls back below four and the track declaration is withdrawn.

### Methodology

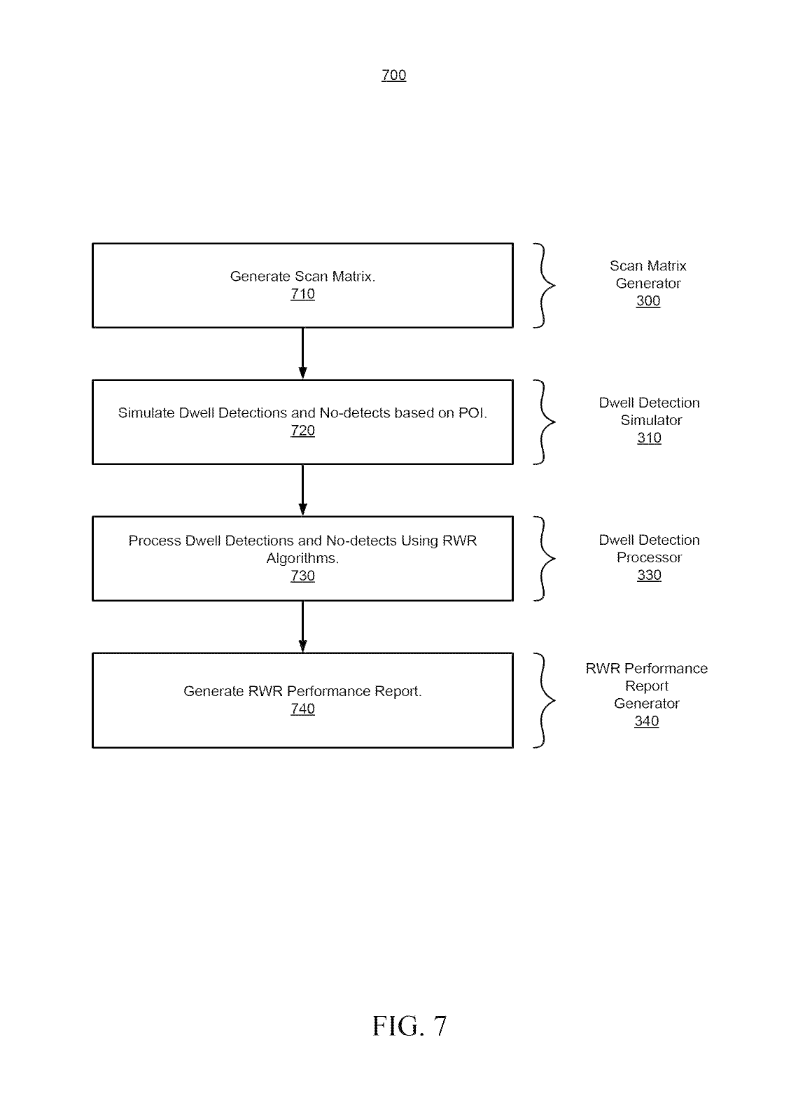

FIG. 7 is a flowchart illustrating a methodology 700 for RWR performance simulation, in accordance with an embodiment of the present disclosure. As can be seen, example method 700 includes a number of phases and sub-processes, the sequence of which may vary from one embodiment to another. However, when considered in aggregate, these phases and sub-processes form a process for simulating the performance of an RWR, in accordance with certain of the embodiments disclosed herein, for example as illustrated in FIGS. 1-6, as described above. However other system architectures can be used in other embodiments, as will be apparent in light of this disclosure. To this end, the correlation of the various functions shown in FIG. 7 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 700 commences, at operation 710, by generating a scan matrix to identify RWR dwells as a function of time. The generation is based on a provided scan schedule that characterizes or otherwise is associated with a threat of interest for use in the simulation. In some embodiments, the RWR dwells specify a frequency band and a time slot. The frequency band of the dwell having a bandwidth based on the instantaneous bandwidth of the RWR. In some embodiments, the scan matrix comprises a list of sequentially ordered RWR dwells, an indication of the dwell type for each of the dwells, and a start time for each of the dwells.

At operation 720, dwell detections are simulated based on a provided POI. The POI characterizes or otherwise is associated with the threat. A dwell detect indicates an occurrence of an illumination by the threat in the RWR dwell. A dwell no-detect indicates the absence of an illumination by the threat in the RWR dwell. In some embodiments, the dwell detections are simulated by comparing an output of a random number generator to a threshold value, the threshold value based on the POI.

At operation 730, the simulated dwell detections are processed using any suitable RWR algorithm to generate a threat declaration. In some embodiments, an example of a processing algorithm of the RWR comprises counting a number of dwell detects in a moving time window and generating the threat declaration by comparing the count to a declaration threshold, as described above. Other RWR algorithms may exist that are configured for specific characteristics of different types of threats.

At operation 740, an indication of simulated performance of the RWR is generated based on the threat declarations.

In some embodiments, additional operations may be performed, as previously described in connection with the system. For example, the method may be iterated for additional threats of interest. For each iteration, a new scan schedule, POI, and RWR algorithm may be employed, as appropriate for that threat. In some embodiments, an RWR performance report is generated. The performance report includes results of processing by the RWR algorithm. In some embodiments, the report comprises correct declaration rates, false alarm rates, and RWR response times for the threat. The report may be used to modify the provided scan schedule.

### Example System

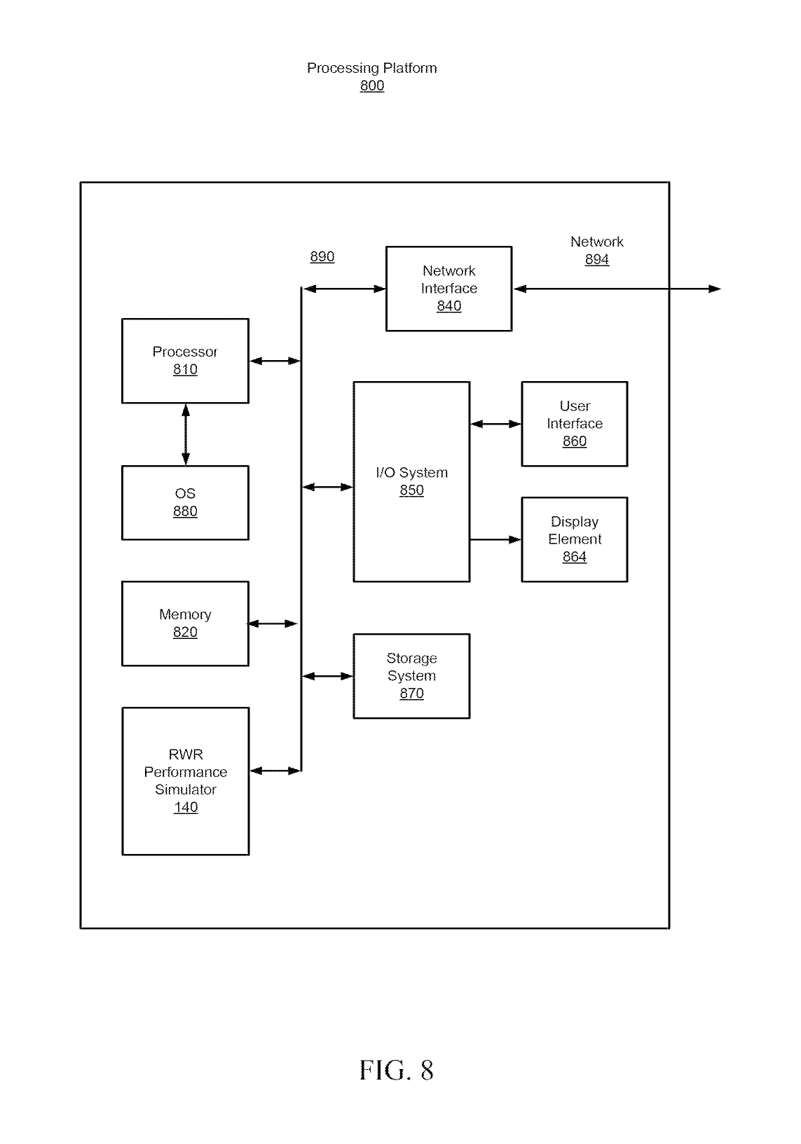

FIG. 8 is a block diagram of a processing platform 800 configured to provide RWR performance simulation, in accordance with an embodiment of the present disclosure. In some embodiments, platform 800, or portions thereof, may be hosted on, or otherwise be incorporated into the electronic systems of an RWR design system. The disclosed techniques may be used to aid in the design of a scan schedule for the RWR.

In some embodiments, platform 800 may comprise any combination of a processor 810, memory 820, RWR performance simulator 140, a network interface 840, an input/output (I/O) system 850, a user interface 860, a display element 864, and a storage system 870. As can be further seen, a bus and/or interconnect 890 is also provided to allow for communication between the various components listed above and/or other components not shown. Platform 800 can be coupled to a network 894 through network interface 840 to allow for communications with other computing devices, platforms, devices to be controlled, or other resources. Other componentry and functionality not reflected in the block diagram of FIG. 8 will be apparent in light of this disclosure, and it will be appreciated that other embodiments are not limited to any particular hardware configuration.

Processor 810 can be any suitable processor, and may include one or more coprocessors or controllers, such as an audio processor, a graphics processing unit, or hardware accelerator, to assist in the execution of the RWR performance simulator 140. In some embodiments, the processor 810 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 810 may be implemented as a complex instruction set computer (CISC) or a reduced instruction set computer (RISC) processor. In some embodiments, processor 810 may be configured as an x86 instruction set compatible processor.

Memory 820 can be implemented using any suitable type of digital storage including, for example, flash memory and/or random access memory (RAM). In some embodiments, the memory 820 may include various layers of memory hierarchy and/or memory caches as are known to those of skill in the art. Memory 820 may be implemented as a volatile memory device such as, but not limited to, a RAM, dynamic RAM (DRAM), or static RAM (SRAM) device. Storage system 870 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 810 may be configured to execute an Operating System (OS) 880 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 800, and therefore may also be implemented using any suitable existing or subsequently-developed platform.

Network interface circuit 840 can be any appropriate network chip or chipset which allows for wired and/or wireless connection between other components of platform 800 and/or network 894, thereby enabling platform 800 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 850 may be configured to interface between various I/O devices and other components of platform 800. I/O devices may include, but not be limited to, user interface 860 and display element 864. User interface 860 may include devices (not shown) such as a touchpad, cockpit display unit, keyboard, and mouse, etc., for example, to allow the user to control the system. Display element 864 may be configured to display information to a user. I/O system 850 may include a graphics subsystem configured to perform processing of images for rendering on the display element 864. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 810 or any chipset of platform 800.

It will be appreciated that in some embodiments, the various components of platform 800 may be combined or integrated in a system-on-a-chip (SoC) architecture. In some embodiments, the components may be hardware components, firmware components, software components or any suitable combination of hardware, firmware or software.

RWR performance simulator 140 is configured to simulate dwell detections based on a provided POI to exercise the algorithms of the RWR and simulate the performance of the RWR, as described previously. RWR performance simulator 140 may include any or all of the circuits/components illustrated in FIG. 3, as described above. These components can be implemented or otherwise used in conjunction with a variety of suitable software and/or hardware that is coupled to or that otherwise forms a part of platform 800. These components can additionally or alternatively be implemented or otherwise used in conjunction with user I/O devices that are capable of providing information to, and receiving information and commands from, a user.

In various embodiments, platform 800 may be implemented as a wireless system, a wired system, or a combination of both. When implemented as a wireless system, platform 800 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 800 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner’s All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 894. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 800 may comprise additional, fewer, or alternative subcomponents as compared to those included in the example embodiment of FIG. 8.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a method for simulating performance of a radar warning receiver (RWR), the method comprising: generating, by a processor-based system, a scan matrix to identify RWR dwells as a function of time, the generation based on a provided scan schedule, the provided scan schedule configured based on one or more characteristics a threat; simulating, by the processor-based system, dwell detections and dwell no-detects based on a provided probability of intercept (POI), the POI indicative of a probability of illumination by the threat within an RWR dwell, wherein a dwell detection is indicative of an occurrence of an illumination by the threat in the RWR dwell and a dwell no-detect is indicative of an absence of an illumination by the threat in the dwell; processing, by the processor-based system, the dwell detections and dwell no-detects to generate threat declarations based on a selected processing algorithm of the RWR, the selection based on the threat; and generating, by the processor-based system, an indication of simulated performance of the RWR based on the threat declarations.

Example 2 includes the method of Example 1, wherein the RWR dwells specify a frequency band and a time slot, the frequency band comprising a bandwidth based on an instantaneous bandwidth of the RWR.

Example 3 includes the method of Examples 1 or 2, wherein the scan matrix comprises a list of sequentially ordered RWR dwells, an indication of dwell type for each of the RWR dwells, and a start time for each of the RWR dwells.

Example 4 includes the method of any of Examples 1-3, further comprising simulating the dwell detections and dwell no-detects by comparing an output of a random number generator to a threshold value based on the POI.

Example 5 includes the method of any of Examples 1-4, wherein the processing algorithm of the RWR comprises counting a number of dwell detections in a moving time window and generating the threat declaration by comparing the count to a declaration threshold.

Example 6 includes the method of any of Examples 1-5, wherein generating the indication of simulated performance further comprises generating a report comprising results of the processing wherein the report includes at least one of threat correct declaration rates, false alarm rates, and RWR response times, and the report is used to modify the provided scan schedule.

Example 7 includes the method of any of Examples 1-6, further comprising iterating the method for a plurality of addition threats of interest.

Example 8 is a computer program product including one or more non-transitory machine-readable mediums encoded with instructions that when executed by one or more processors cause a process to be carried out for simulating performance of a radar warning receiver (RWR), the process comprising: generating a scan matrix to identify RWR dwells as a function of time, the generation based on a provided scan schedule, the provided scan schedule configured based on one or more characteristics a threat; simulating dwell detections and dwell no-detects based on a provided probability of intercept (POI), the POI indicative of a probability of illumination by the threat within an RWR dwell, wherein a dwell detection is indicative of an occurrence of an illumination by the threat in the RWR dwell and a dwell no-detect is indicative of an absence of an illumination by the threat in the dwell; processing the dwell detections and dwell no-detects to generate a threat declaration based on a selected processing algorithm of the RWR, the selection based on the threat; and generating an indication of simulated performance of the RWR based on the threat declarations.

Example 9 includes the computer program product of Example 8, wherein the RWR dwells specify a frequency band and a time slot, the frequency band comprising a bandwidth based on an instantaneous bandwidth of the RWR.

Example 10 includes the computer program product of Examples 8 or 9, wherein the scan matrix comprises a list of sequentially ordered RWR dwells, an indication of dwell type for each of the RWR dwells, and a start time for each of the RWR dwells.

Example 11 includes the computer program product of any of Examples 8-10, wherein the process further comprises simulating the dwell detections and dwell no-detects by comparing an output of a random number generator to a threshold value based on the POI.

Example 12 includes the computer program product of any of Examples 8-11, wherein the processing algorithm of the RWR comprises counting a number of dwell detections in a moving time window and generating the threat declaration by comparing the count to a declaration threshold.

Example 13 includes the computer program product of any of Examples 8-12, wherein generating the indication of simulated performance further comprises generating a report comprising results of the processing wherein the report includes at least one of threat correct declaration rates, false alarm rates, and RWR response times, and the report is used to modify the provided scan schedule.

Example 14 includes the computer program product of any of Examples 8-13, wherein the process further comprises iterating the method for a plurality of addition threats of interest.

Example 15 is a radar warning receiver (RWR) simulator comprising: a scan matrix generator configured to generate a scan matrix to identify RWR dwells as a function of time, the generation based on a provided scan schedule, the provided scan schedule configured based on one or more characteristics a threat; a dwell detection simulator configured to simulate dwell detections and dwell no-detects based on a provided probability of intercept (POI), the POI indicative of a probability of illumination by the threat within an RWR dwell, wherein a dwell detection is indicative of an occurrence of an illumination by the threat in the RWR dwell and a dwell no-detect is indicative of an absence of an illumination by the threat in the dwell; a dwell detection processor configured to process the dwell detections and dwell no-detects to generate a threat declaration based on a selected processing algorithm of the RWR, the selection based on the threat; and a performance report generator configured to generate a report comprising results of the processing, the report used to modify the provided scan schedule.

Example 16 includes the RWR simulator of Example 15, wherein the RWR dwells specify a frequency band and a time slot, the frequency band comprising a bandwidth based on an instantaneous bandwidth of the RWR.

Example 17 includes the RWR simulator of Examples 15 or 16, wherein the scan matrix comprises a list of sequentially ordered RWR dwells, an indication of dwell type for each of the RWR dwells, and a start time for each of the RWR dwells.

Example 18 includes the RWR simulator of any of Examples 15-17, wherein the dwell detection simulator is configured to compare an output of a random number generator to a threshold value based on the POI and simulate the dwell detections based on the comparison.

Example 19 includes the RWR simulator of any of Examples 15-18, wherein the processing algorithm of the RWR comprises counting a number of dwell detections in a moving time window and generating the threat declaration by comparing the count to a declaration threshold.

Example 20 includes the RWR simulator of any of Examples 15-19, wherein the report comprises at least one of threat correct declaration rates, false alarm rates, and RWR response times.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A method for simulating performance of a radar warning receiver (RWR), the method comprising:
generating, by a processor-based system, a scan matrix to identify RWR dwells as a function of time, the generation based on a provided scan schedule, the provided scan schedule configured based on one or more characteristics a threat;
simulating, by the processor-based system, dwell detections and dwell no-detects based on a provided probability of intercept (POI), the POI indicative of a probability of illumination by the threat within an RWR dwell, wherein a dwell detection is indicative of an occurrence of an illumination by the threat in the RWR dwell and a dwell no-detect is indicative of an absence of an illumination by the threat in the dwell;
processing, by the processor-based system, the dwell detections and dwell no-detects to generate threat declarations based on a selected processing algorithm of the RWR, the selection based on the threat; and
generating, by the processor-based system, an indication of simulated performance of the RWR based on the threat declarations.

2. The method of claim 1, wherein the RWR dwells specify a frequency band and a time slot, the frequency band comprising a bandwidth based on an instantaneous bandwidth of the RWR.

3. The method of claim 1, wherein the scan matrix comprises a list of sequentially ordered RWR dwells, an indication of dwell type for each of the RWR dwells, and a start time for each of the RWR dwells.

4. The method of claim 1, further comprising simulating the dwell detections and dwell no-detects by comparing an output of a random number generator to a threshold value based on the POI.

5. The method of claim 1, wherein the processing algorithm of the RWR comprises counting a number of dwell detections in a moving time window and generating the threat declaration by comparing the count to a declaration threshold.

6. The method of claim 1, wherein generating the indication of simulated performance further comprises generating a report comprising results of the processing wherein the report includes at least one of threat correct declaration rates, false alarm rates, and RWR response times, and the report is used to modify the provided scan schedule.

7. The method of claim 1, further comprising iterating the method for a plurality of addition threats of interest.

8. A computer program product including one or more non-transitory machine-readable mediums encoded with instructions that when executed by one or more processors cause a process to be carried out for simulating performance of a radar warning receiver (RWR), the process comprising:
generating a scan matrix to identify RWR dwells as a function of time, the generation based on a provided scan schedule, the provided scan schedule configured based on one or more characteristics a threat;
simulating dwell detections and dwell no-detects based on a provided probability of intercept (POI), the POI indicative of a probability of illumination by the threat within an RWR dwell, wherein a dwell detection is indicative of an occurrence of an illumination by the threat in the RWR dwell and a dwell no-detect is indicative of an absence of an illumination by the threat in the dwell;
processing the dwell detections and dwell no-detects to generate a threat declaration based on a selected processing algorithm of the RWR, the selection based on the threat; and
generating an indication of simulated performance of the RWR based on the threat declarations.

9. The computer program product of claim 8, wherein the RWR dwells specify a frequency band and a time slot, the frequency band comprising a bandwidth based on an instantaneous bandwidth of the RWR.

10. The computer program product of claim 8, wherein the scan matrix comprises a list of sequentially ordered RWR dwells, an indication of dwell type for each of the RWR dwells, and a start time for each of the RWR dwells.

11. The computer program product of claim 8, wherein the process further comprises simulating the dwell detections and dwell no-detects by comparing an output of a random number generator to a threshold value based on the POI.

12. The computer program product of claim 8, wherein the processing algorithm of the RWR comprises counting a number of dwell detections in a moving time window and generating the threat declaration by comparing the count to a declaration threshold.

13. The computer program product of claim 8, wherein generating the indication of simulated performance further comprises generating a report comprising results of the processing wherein the report includes at least one of threat correct declaration rates, false alarm rates, and RWR response times, and the report is used to modify the provided scan schedule.

14. The computer program product of claim 8, wherein the process further comprises iterating the method for a plurality of addition threats of interest.

15. A radar warning receiver (RWR) simulator comprising:
a scan matrix generator configured to generate a scan matrix to identify RWR dwells as a function of time, the generation based on a provided scan schedule, the provided scan schedule configured based on one or more characteristics a threat;
a dwell detection simulator configured to simulate dwell detections and dwell no-detects based on a provided probability of intercept (POI), the POI indicative of a probability of illumination by the threat within an RWR dwell, wherein a dwell detection is indicative of an occurrence of an illumination by the threat in the RWR dwell and a dwell no-detect is indicative of an absence of an illumination by the threat in the dwell;
a dwell detection processor configured to process the dwell detections and dwell no-detects to generate a threat declaration based on a selected processing algorithm of the RWR, the selection based on the threat; and
a performance report generator configured to generate a report comprising results of the processing, the report used to modify the provided scan schedule.

16. The simulator of claim 15, wherein the RWR dwells specify a frequency band and a time slot, the frequency band comprising a bandwidth based on an instantaneous bandwidth of the RWR.

17. The simulator of claim 15, wherein the scan matrix comprises a list of sequentially ordered RWR dwells, an indication of dwell type for each of the RWR dwells, and a start time for each of the RWR dwells.

18. The simulator of claim 15, wherein the dwell detection simulator is configured to compare an output of a random number generator to a threshold value based on the POI and simulate the dwell detections based on the comparison.

19. The simulator of claim 15, wherein the processing algorithm of the RWR comprises counting a number of dwell detections in a moving time window and generating the threat declaration by comparing the count to a declaration threshold.

20. The simulator of claim 15, wherein the report comprises at least one of threat correct declaration rates, false alarm rates, and RWR response times.
